(19) United States
(12) Patent Application Publication
(10) Pub. No.: US 2015/0336289 A1
(43) Pub. Date: Nov. 26, 2015

(54) A Reusable Inwardly Collapsible Void Former

(71) Applicant: Obelix Holdings Pty Ltd., North Sydney, New South Wales, OT (AU)

(72) Inventors: Ernest Frederick Comerford, North Sydney (AU); Mark Andrew Rankin, North Sydney (AU); Jamie Taylor, North Sydney (AU)

(73) Assignee: Obelix Holdings Pty Ltd., North Sydney, New South Wales (AU)

(21) Appl. No.: 14/424,908

(22) PCT Filed: Aug. 30, 2013
(86) PCT No.: PCT/AU2013/000980

§ 371 Date: Feb. 27, 2015

(30) Foreign Application Priority Data
Aug. 31, 2012 (AU) 2012903759

(51) Int. Cl. B28B 7/30; B28B 1/14; B28B 7/28; B28B 7/18

(52) U.S. Cl. CPC B28B 7/306; B28B 7/18; B28B 1/14; B28B 7/285

(57) ABSTRACT

A re-useable void former for forming voids in concrete structures adapted to be positioned in wet concrete being of a flexible and elastic material to allow the void former to pucker inwardly when unsupported; a retainer adapted to support and maintain the outer shape as the concrete sets; a remover adapted to engage the void former on withdrawing the retainer wherein the unsupported void former is able to pucker and be pulled from the void thus formed for reuse. A method of use of the invention.

### FIELD OF THE INVENTION

This invention relates to the construction and building industries and in particular to a re-useable flexible and elastic inwardly collapsible void former for use in the pre cast method of construction and for the location of suitable hold down mountings for machinery and the like.

### BACKGROUND OF THE INVENTION

The use of prior art lifting devices in the tilt slab method of precast concrete construction is well established. These devices generally involve a lifter typically a releasing hook attached to a lifting crane that engages an eye or lifting point embedded in the concrete slab or structure which is then removed and the remaining void covered over. Recent development has led to the use of disposable permanently embedded void formers which allow a specially adapted lifter to engage and disengage directly the void thereby dispensing with the necessity of embedded lifting eyes or points. An example of this system is disclosed in WO/2010/045692 (Comerford et. el). A significant limitation with this system is that as the void former has a flared or conical end to accommodate the expandable and retractable wedges or fingers of the lifter device the void former becomes captive and permanently trapped in the concrete void. Void inserts are also often used when mounting machinery to concrete floors or platforms. In the case where heavy vibration is experienced, prior art fixtures or inserts can often be loosened or even pulled out with the possibility of disastrous consequences. As a result, it has been realised that if the voids were able to be created without the need for expensive consumable inserts, which may also compromise structural integrity by the inclusion of a different material, that this would obviously result in an obvious and significant cost advantage.

### OBJECT OF THE INVENTION

It is the object of the invention to ameliorate some or all of the above limitations disadvantages of the prior art by providing a novel and innovative re-useable inwardly collapsible void former for use in precast concrete structures and for the anchoring of machinery, plant or equipment or any fixture and to at least provide the public with a useful choice.

### STATEMENT OF INVENTION

In one aspect the invention resides in a re-useable inwardly collapsible void former for forming voids in concrete structures including in combination:

a hollow tube adapted to be positioned or inserted in wet concrete;

the tube having an outer shape or configuration of the intended void;

the tube being of a flexible and elastic material to allow the tube to pucker and collapse inwardly wherein it can be pulled from the void formed on curing of the concrete.

Preferably, a removable retainer is inserted into the tube to support and prevent the void former from collapsing inwardly as the concrete sets.

Preferably, the removable retainer is a tubular mandrel which is pre slid into the tube to maintain the integrity and outer shape of the tube when under pressure of the wet concrete.

Preferably, on withdrawing the retainer, a tube remover is used to pull the void former from the void formed.

Preferably, the tube has a frustoconical section which creates a correspondingly shaped void adapted to be engaged by an expanding and releasing lifting tool.

Where the void is to be used for fixing machinery, plant or equipment or fixture to a concrete floor or platform, or where the void is used to hold any temporary fixing device, the frustoconical section provides an undercut shelf for a bolt with an expanding end or other suitable expanding plug or insert to provide a positively anchored or captively locked fixture.

Preferably, the tube is moulded from a flexible and resilient material such as Nitrile ^{TM} or an equally durable synthetic rubber. In the alternative natural rubber or any other suitable material may be used.

Preferably, the material may include a lubricating compound which is slowly released to facilitate removal of the void former from the cured concrete.

Preferably, the tube has an aperture at its lower end to facilitate puckering and a biased inward contraction of the tube on removal.

Preferably, the retainer is a tubular mandrel which is pre slid into the tube to maintain the integrity and outer shape of the tube when under pressure from the wet concrete.

Preferably the retainer has one or more air holes to prevent vacuum suction hindering its removal from the tube.

The retainer also preferably plugs the lower aperture in the tube which facilitates its puckering as well as preventing the ingress of wet concrete into the tube.

Preferably, the upper portion of the tube has a configuration adapted to positively engage the remover. This may include complementary grooves, or ridges which results in a firm connection as the tube is pulled from the concrete.

Preferably, the upper portion of the tube sits proud of the surface of the concrete structure and is adapted to be clamped to the tube remover by a releasable clamp.

In another aspect the invention resides in a method of forming voids in concrete structures with a re-useable void former as hereinbefore described including the steps of:

inserting a removable retainer into the void former adapted to support and maintain its outer shape;

positioning the void former with the retainer in the wet concrete of the structure; withdrawing the retainer on curing of the concrete, and pulling out the unsupported and inwardly collapsible void former from the void formed in the cured concrete for reuse.

Preferably, on withdrawing the retainer, a tube remover is used to pull out the unsupported and inwardly collapsible void former from the void formed in the set concrete for reuse.

### BRIEF DESCRIPTION OF THE DRAWINGS

In order for the invention to be better understood reference will now be made to the accompanying drawings, wherein;

FIGS. 1a-1f show various views of a preferred tube or void former according to the invention.

FIGS. 2a-2i show various views of components of a preferred tube retainer.

FIGS. 3a-3c show an assembled tube retainer of FIGS. 2a-2i.

FIGS. 4a-4c show a preferred tube remover or void release.

### DETAILED DESCRIPTION OF THE DRAWINGS

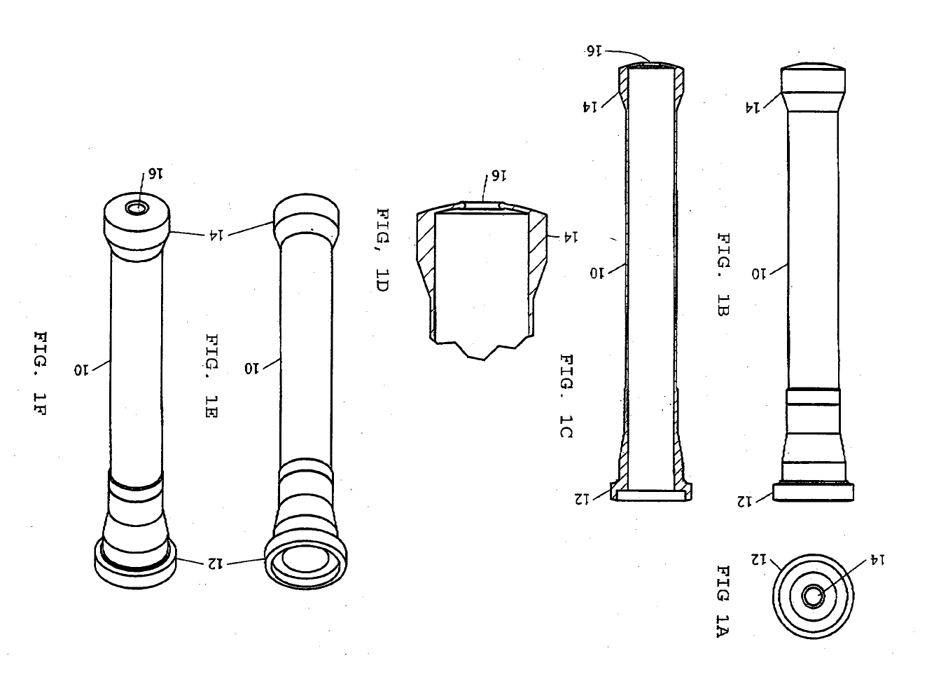

Referring now to FIGS. 1a-1f there is shown a preferred tube assembly according to the invention. In particular, FIG. 1c is a cross section through section AA of plan view FIG. 1a. FIG. 1d shows detail of the lower portion of FIG. 1c. The tube comprises an elongate hollow body 10 an upper portion 12 configured to receive a tube remover (not shown). The lower portion of the tube has a frusto conical configuration 14 adapted to produce a similar shaped void in concrete for lifting by a lifting device (not shown) or to provide an undercut shelf for any expanding bolt ,plug or insert when used for fixing any machinery, plant or equipment or fixture(not shown). The lower portion also has an aperture 16 to allow the tube to pucker wherein the frusto conical portion is allowed to collapse or contract internally to facilitate removal of the tube from the concrete.

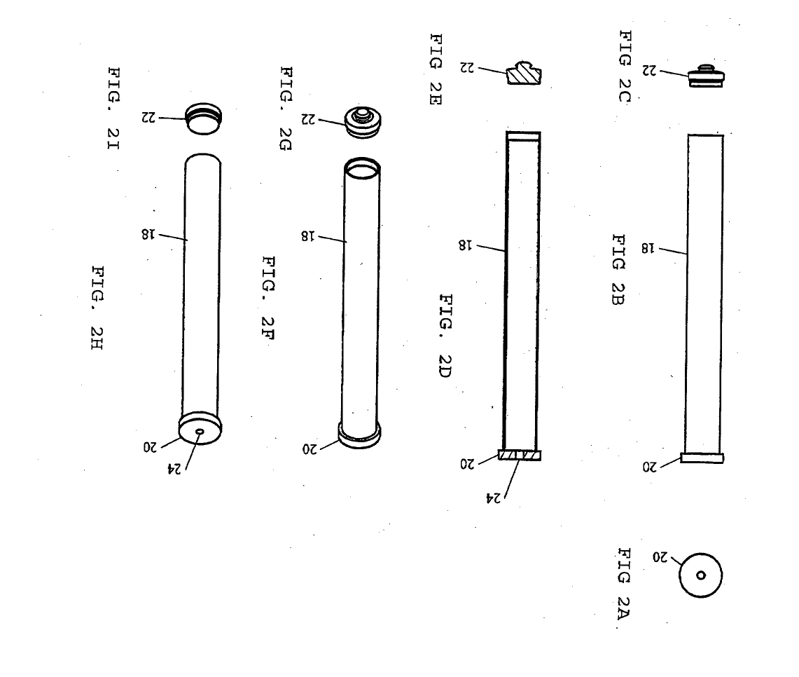

Referring to FIGS. 2a-2i there is shown a preferred tube retainer assembly and components according to the invention. FIGS. 2d and 2c are cross sections through section CC of plan view FIG. 2a.

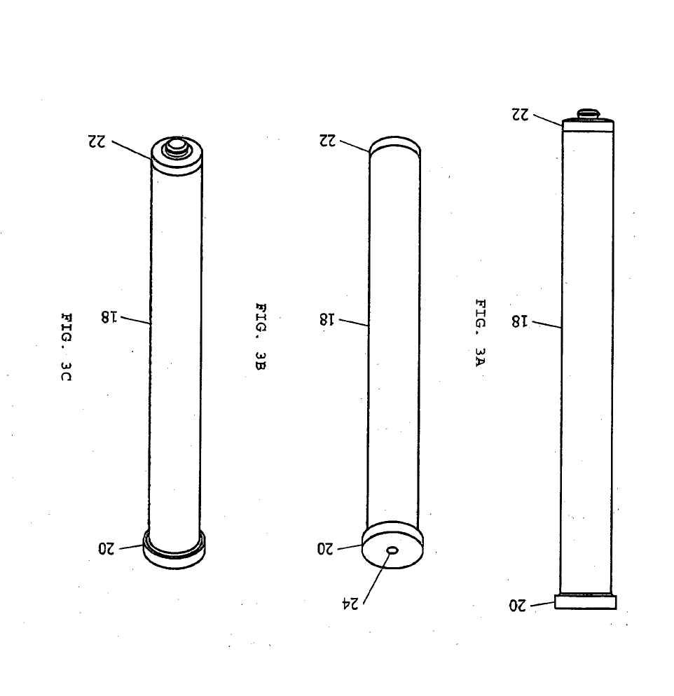

Referring now to FIGS. 3a-3c there is shown the tube retainer of FIG. 2 in the completely assembled state. Numbering of the components have been kept consistent between all illustrations in the interest of clarity.

The tube retainer 18 is of an elongate configuration with smooth outer walls to facilitate sliding into the tube (of FIG. 1). In this example, the retainer has a fixed upper cap 20 and a detachable lower plug 22. The upper cap has a hole 24 to prevent vacuum suction from hindering the withdrawal of the retainer from the tube (not shown).

The plug 22 at the lower portion is designed to plug the aperture at the bottom of the tube to prevent the ingress of concrete filling the tube. Preferably the plug is detachable and is retrieved with the tube (not shown) when it is removed from the concrete.

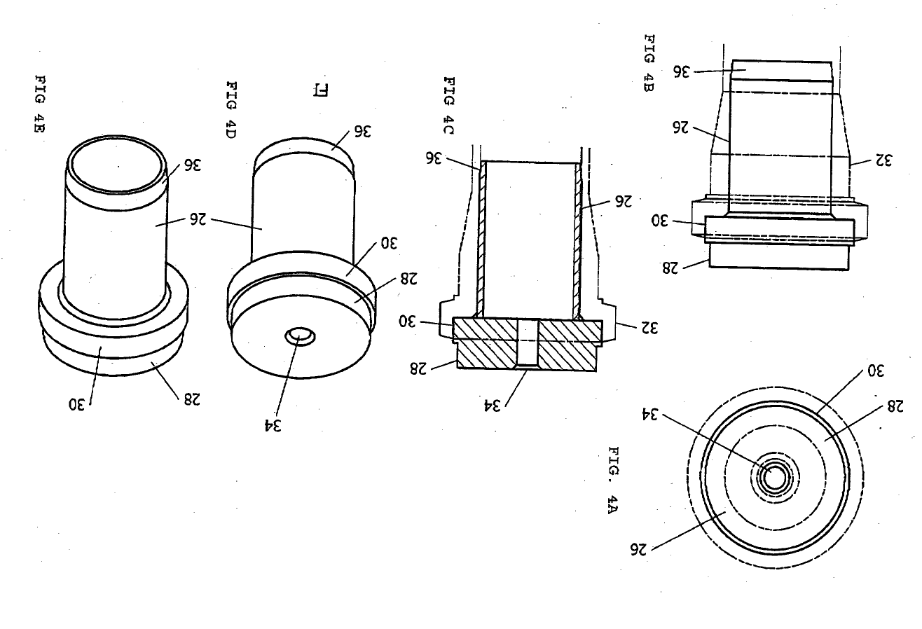

FIGS. 4a-4c shows various views of a preferred tube remover 26 or void release. FIG. 4c is a cross section through section DD of plan view, FIG. 4a.

The remover or release has an outer configuration of steps or ridges 28, 30 which are designed to engage the complementary shaped upper portion of a tube or void rubber (shown by the phantom lines 32). Preferably, the remover has a hole 34 to allow air to be expelled as the tube puckers and collapses inwardly as it is being removed from the void formed.

The remover has a tapered section 36 to facilitate insertion into the tube wherein a releasable circle clamp (not shown) is used to clamp the upper portion of the tube against the remover so that by pulling on the remover enables the tube to be removed from the void formed. It will be obvious that it is preferable that the tube or void rubber is of a greater length than the void to be formed to facilitate the removal process.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

In addition to the above, it should be appreciated that throughout the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

1. A re-useable inwardly collapsible void former for forming voids in concrete structures including in combination:
a hollow tube adapted to be positioned or inserted in wet concrete;
the tube having an outer shape or configuration of the intended void;
the tube being of a flexible and elastic material to allow the tube to pucker and collapse inwardly wherein it can be pulled from the void formed on curing of the concrete.

2. The void former of claim 1 wherein a removable retainer is inserted into the tube to support and prevent the void former from collapsing inwardly as the concrete sets.

3. The void former of claim 2 wherein the retainer is a tubular mandrel which is pre slid into the tube to maintain the integrity and outer shape of the tube when under pressure of wet concrete.

4. The void former of claim 1 wherein a tube remover is used to pull the void former from the void formed.

5. The void former of claim 1 wherein the tube has a frustoconical section which creates a correspondingly shaped void adapted to be engaged by an expanding and releasing lifting tool.

6. The void former of claim 5 wherein the frustoconical section provides an undercut shelf for a bolt, plug or insert with an expanding end insert to provide a positively anchored or captively locked fixture.

7. The void former of claim 1 wherein the tube has an aperture at its lower end to facilitate puckering and a biased inward contraction of the tube on removal.

8. The void former of claim 1 wherein the retainer has one or more air holes to prevent vacuum suction hindering its removal from the tube.

9. The void former of claim 1 wherein the retainer plugs any holes or apertures in the tube and prevents the ingress of wet concrete into the tube.

10. The void former of claim 1 wherein an upper portion of the tube has a configuration adapted to positively engage a tube remover.

11. The void former of claim 10 wherein the upper portion of the tube includes complementary grooves or ridges to provide a firm connection with the tube remover as the tube is pulled from the concrete.

12. The void former of claim 1 wherein an upper portion of the tube sits proud of the surface of the concrete structure and is adapted to be clamped to a tube remover by a releasable clamp.

13. The void former of claim 1 wherein the tube is moulded from a flexible and resilient material.

14. The void former of claim 13 wherein the material includes a lubricating compound which is slowly released to the surface of the material to facilitate removal of the void former from cured concrete.

15. A method of forming voids in concrete structures comprising the steps of:
providing a re-useable void former comprising a hollow tube adapted to be positioned or inserted in wet concrete, wherein the tube has an outer shape corresponding to the intended void and is made from a flexible and elastic material so as to allow the tube to pucker and collapse inwardly so that it can be pulled from the void formed upon curing of the concrete;
inserting a removable retainer into the void former adapted to support and maintain its outer shape;
positioning the void former with the retainer in wet concrete of the structure;
withdrawing the retainer upon curing of the concrete, and pulling out the unsupported and inwardly collapsible void former from the void formed in the cured concrete for reuse.

16. The method of claim 15 wherein on withdrawing the retainer, a tube remover is used to pull out the unsupported and inwardly collapsible void former from the void formed for reuse.
